(19) United States
(12) Patent Application Publication
(10) Pub. No.: US 2013/0118380 A1
(43) Pub. Date: May 16, 2013

(54) SYSTEM OF INTERFERENCE PIGMENTS

(71) Applicants: Michael ROESLER, Reinheim (DE); Adalbert HUBER, Bensheim (DE)

(72) Inventors: Michael ROESLER, Reinheim (DE); Adalbert HUBER, Bensheim (DE)

(73) Assignee: MERCK PATENT GESELLSCHAFT MIT BESCHRANKTER HAFTUNG, Darmstadt (DE)

(21) Appl. No.: 13/570,538

(22) Filed: Aug. 9, 2012

Related U.S. Application Data
(63) Continuation of application No. 11/997,782, filed on Feb. 4, 2008, now abandoned.

(30) Foreign Application Priority Data
Aug. 3, 2005 (DE) 102005037095.0

(51) Int. Cl. C09C 3/06

(52) U.S. Cl. CPC C09C 3/063
USPC 106/417; 106/442; 106/446

(57) ABSTRACT

A system of N≧3 interference pigments, which is distinguished in that it exhibits a maximum color gamut through specification of the optimum pigment hue angle h_{u′v′}ⁱ (i=1 to N) in the CIELUV system.

This application is a Continuation of U.S. patent application Ser. No. 11/997,782, filed Feb. 4, 2008, which is incorporated by reference herein.

The present invention relates to a system comprising N interference pigments, which is distinguished by the fact that, for any given number N, the hue angles h_{u′v′}ⁱ (i=1 to N, where N≧3) maximise the colour gamut of the system. The system comprises a range of interference pigments of high tinting strength, and blends thereof.

Lustre or effect pigments are employed in many areas of industry, in particular in the area of industrial and automotive paints and coatings, decorative coating, in plastic, in inks, printing inks and in cosmetic formulations.

Since hiding power, gloss and colour usually cannot be achieved by means of a single pigment in the formulation, pigments are frequently mixed with one another. The number of respective independent colours to be achieved by interference pigments is generally inadequate in the formulations, meaning that mixtures have to be prepared from commercially available pigments in order to satisfy the requirements of designers for the largest possible number of different colours. For economic reasons, however, it is necessary to manage with as few pigments as possible. There is thus a demand for effect pigments which are of such a nature that as many colours as possible can be mixed from them, where the number of different pigment types necessary for this purpose should be small.

Metrological characterisation of the colours of effect pigments for quality assurance or in order to estimate colouristic possibilities on blending with typical other components of a surface-coating formulation is carried out in accordance with the prior art by means of goniospectrometers on samples prepared from effect pigments. The resultant spectra are then converted, with reference to reference conditions laid down in standards (nature of the light source, nature of the observer, etc.), into colour coordinates X, Y, Z, or x, y, Y, or L*, a* and b*, which can be utilised both for assessment of the angle-dependent colour behaviour of an effect pigment and also for assessment of the differences between two or more effect pigments. In the area of the surface coatings and inks industry, the CIE L*a*b* colour system is preferred here, with the conversion from x, y, Y to L*a*b* being laid down in the DIN standard DIN 5033. It follows from this non-linear conversion that the property of additivity of light colours, which is still present in the x, y, Y system, no longer applies to the L*a*b* system. However, since the transparent effect pigments considered here “mix with one another like light colours” (additive mixture), the L*a*b* system is not suitable for the present optimisation tasks. However, a colour coordinate system which is suitable for this purpose exists, with the colour coordinates u′, v′ and Y, which
a) retains the linearity of the additive colour mixture from the x, y, Y system and
b) has improved perceived equidistance of colour differences compared with x, y, Y.

A u′v′ hue angle can then be defined analogously to the x, y system as

$${h}_{{u}^{′} {v}^{′}} = arctan ( \frac{{v}^{′} - {v}_{n}^{′}}{{u}^{′} - {u}_{n}^{′}} ) ,$$

where u′ₙ and v′ₙ are the colour coordinates of the achromatic point.

The saturation S_{u′,v′} is proportional here to the Cartesian metric

S_{u′v′}=13\sqrt{(u′−u′ₙ)²+(v′−v′ₙ)²},

analogously to the CIE L*a*b* colour space.

The object of the present invention is therefore to find interference pigments whose blends have the greatest possible colour gamut in the u′, v′ plane of the u′, v′, Y colour space in the CIELUV system. By choosing and preparing coloured interference pigments having precisely defined colours, the aim is to achieve the maximum colour gamut for a given system comprising N interference pigments. In order to achieve an adequate colour impression, it is a prerequisite that the value δ=S_{u′v′}/13 of the individual pigments reaches at least 0.05, preferably exceeds 0.15.

Surprisingly, it has now been found that a system consisting of N interference pigments having defined hue angles h_{u′v′}ⁱ (i=1 to N, where N≧3) results in the greatest possible colour gamut that can be formed at all from N interference pigments.

A “construction kit” of interference pigments is thus present whose mutual blending in varying composition allows the production of all individual colours that are possible in a colour space defined by this “construction kit”.

The invention thus relates to a system comprising N≧3 interference pigments, characterised in that it has a maximum colour gamut and the optimum hue angles h_{u′v′}ⁱ (i=1 to N) for this purpose, with a tolerance of ±2° in the CIELUV system, at a C_{u′v′} of ≧0.05 of the individual pigments.

The invention also relates to coloured interference pigments of high tinting strength having defined hue angles and chroma as constituents of the system comprising N interference pigments.

The gamut of a defined selection of more than two effect pigments is the range of colour coordinates that can be achieved by additive mixing of these interference pigments in a surface-coating layer for a given illumination (angle, illuminant, aperture) and detection (angle, aperture). Since the gamut is used here as a polygonal area in the u′v′ plane of the u′v′Y system, no change takes place in the colour gamut (in contrast to the a*b* gamut) on variation of the coating layer thicknesses d and/or the pigment mass concentration (PMC) of the effect pigments in the range specified by practice (d<50 μm and PMC<30 m %). The colour coordinates of all effect-pigmented coating layers are measured with one of the geometries provided by conventional goniometric colorimetry.

The 45°/120° geometry used here for measurement of the spectral composition of the reflected light is therefore preferred since it enters both the set of measurement geometries in accordance with ASTM E2194 and DIN 6175-2 and to this extent preferably for metallics, and also the set of colour measurement geometries in accordance with ASTM WK 1164 April 2006 and to this extent preferably for interference pigments. It is implemented in all multiangle colorimeters available to date for the measurement of planar colour samples.

For simplification, but without restricting generality, colour samples here are always taken to mean those in which a pigment mass concentration of 16.3 m %, a layer thickness of the base coat of 15 μm and pneumatic application both of the base coat and also of the overlying clear coat are used.

All colour locations of effect pigments which satisfy the following conditions: high-refractive-index, transparent metal oxide/transparent substrate/high-refractive-index metal oxide, are on spiral, but intersecting curves around the achromatic point in the u′v′ system. The convex envelope of this curve set E(u′,v′) characterises the amount of the most chromatic effect pigments that are potentially possible for each existing hue angle. Each mixture of effect pigments (which lie on E(u′,v′)) can only give rise to colour locations which are on the lines connecting these two effect pigments, and E(u′,v′) is thus replaced by the area content of the polygon P(u′ⁱ,v′ⁱ) with which N=3 to i.

The curve E(u′,v′) “rotates counterclockwise” on transition from steep to flat viewing angles for measurement geometries having the same angular separation from specular. It tightens around the achromatic point on transition from close-to-specular viewing angles to far-from-specular viewing angles if the illumination direction remains constant.

It has now been found, however, that the shape of curve E(u′,v′) remains substantially constant for all measurement geometries, so that the pigments which have optimum h_{u′v′} hue angles, i.e. ones which maximise the u′,v′ gamut, at, for example, 45°/120° [according to the system of notation in the ASTM draft standard ‘Practice for Multiangle Color Measurement of Materials Colored with Interference Pigments’, 2004] are also those which give rise to the maximum gamut at another measurement geometry, but now with different hue angles.

The curve E(u′,v′) for the present multilayered structures (high-refractive-index, transparent metal oxide (MeO)/transparent substrate/high-refractive-index, transparent metal oxide) having layer-thickness variances of the substrate >100 nm can theoretically be derived with adequate accuracy (ΔE<1) from the interference curves of the single-layered system. Corresponding formulae are known from the relevant literature (for example from Vasicek, A., Optics of Thin Films, 1960, North Holland Pub. Comp., Amsterdam).

In particulate systems having varying interference properties from effect-pigment particle to effect-pigment particle, and different orientations of the effect-pigment particles, the uv chroma C_{u′v′} of the ideal layer structure extended to infinity is usually not achieved, although the shape of the curve E(u′,v′), as can be monitored with reference to practical pigment coating curves, remains constant. For titanium-dioxide coatings deposited from the liquid phase on mica, the curve E(u′,v′) shown in FIG. 1 is determined as theoretical and practical limit curve (envelope) in a representative manner for all systems: MeO/transparent substrate having layer-thickness standard deviations >100 nm/MeO. All u′v′ colour locations determined of samples of interference pigments with any desired setting of the optical thickness of the metal oxide in coatings (measured in the 45°/120° measurement geometry on an absorbent substrate) can thus be found inside the curve E(u′,v′) or a congruent curve having reduced uv chroma.

The shape of the envelope curve E(u′,v′) (see FIG. 1) is the basis of an optimisation procedure for the selection of favourable “cut-off angles” of effect pigments h_{u′v′}ⁱ (i=1 to N, where N≧3).

In this way, it is then possible to position a number N of pigments on the envelope curve and thus to create a system of interference pigments which satisfies one of the two criteria mentioned:
a) has the maximum u′v′ area of the 2-dimensional polygon of the selected pigments, or
b) has the maximum u′v′Y volume of the 3-dimensional polyhedron of the selected pigments.

Since the latter criterion is not independent of the selected pigment use concentrations and the material constants of the pigments, an optimisation is carried out in accordance with a) in which the area content of all potentially possible polygons P(u′ⁱ,v′ⁱ) corresponding to the u′,v′ colour value fractions of the envelope curve E(u′,v′) (and thus of the h_{u′v′} hue angles) in the u′v′ system is numerically maximised, and, for N=3 to 8, the optimum h_{u′v′} hue angles necessary for this purpose are determined.

In this way, the u′,v′ coordination of the colour locations is obtained for interference pigments which, alone or through blending, facilitate the maximum number of colours with the minimum number of pigments.

Particularly preferred pigments according to the invention have the following hue ranges (pure tone on black, in 45°/120° colour measurement geometry [according to the system of notation in the ASTM draft standard ‘Practice for Multiangle Color Measurement of Materials Colored with Interference Pigments’, 2004], pneumatic spray application):

TABLE 1

−127.3 > hᵤᵥ > −133.3
−112.2 > hᵤᵥ > −118.2
−96.4 > hᵤᵥ > −102.4
−81.1 > hᵤᵥ > −87.1
−67.4 > hᵤᵥ > −73.4
−55.6 > hᵤᵥ > −61.6
−29.5 > hᵤᵥ > −35.5
−9.8 > hᵤᵥ > −15.8
−3.4 > hᵤᵥ > −9.4
3.2 > hᵤᵥ > −2.8
52.8 > hᵤᵥ > 46.8
67.7 > hᵤᵥ > 61.7
157.1 > hᵤᵥ > 151.1
163.6 > hᵤᵥ > 157.6
169.8 > hᵤᵥ > 163.8
183.0 > hᵤᵥ > 177.0

In particular, coloured interference pigments from the following hue angle and chroma ranges are preferred for the preparation of pigment mixtures comprising N pigments (where δ=S_{u′v′}/13=\sqrt{(u′−u′ₙ)²+(v′−v′ₙ)²}):

TABLE 2

−127.3 > hᵤᵥ > −133.3 and Cᵤᵥ > 0.05 for N = 6
−112.2 > hᵤᵥ > −118.2 and Cᵤᵥ > 0.14 for N = 4, 5, 7, 8
−112.2 > hᵤᵥ > −116.6 and Cᵤᵥ > 0.05 for N = 4, 5, 7, 8
−96.4 > hᵤᵥ > −102.4 and Cᵤᵥ > 0.05 for N = 3, 6, 8
−81.1 > hᵤᵥ > −87.1 and Cᵤᵥ > 0.125 for N = 5, 7, 8
−81.1 > hᵤᵥ > −86.7 and Cᵤᵥ > 0.05 for N = 5, 7, 8
−67.4 > hᵤᵥ > −73.4 and Cᵤᵥ > 0.12 for N = 4, 6
−67.4 > hᵤᵥ > −72.7 and Cᵤᵥ > 0.05 for N = 4, 6
−55.6 > hᵤᵥ > −61.6 and Cᵤᵥ > 0.05 for N = 7, 8
−29.5 > hᵤᵥ > −35.5 and Cᵤᵥ > 0.05 for N = 5
−9.8 > hᵤᵥ > −15.8 and Cᵤᵥ > 0.062 for N = 6
−9.8 > hᵤᵥ > −12.7 and Cᵤᵥ > 0.05 for N = 6
−3.4 > hᵤᵥ > −9.4 and Cᵤᵥ > 0.057 for N = 7, 8
−3.4 > hᵤᵥ > −7.8 and Cᵤᵥ > 0.05 for N = 7, 8
3.2 > hᵤᵥ > −2.8 and Cᵤᵥ > 0.05 for N = 3
52.8 > hᵤᵥ > 46.8 and Cᵤᵥ > 0.05 for N = 4
67.7 > hᵤᵥ > 61.7 and Cᵤᵥ > 0.05 for N = 5, 6, 7, 8
157.1 > hᵤᵥ > 151.1 and Cᵤᵥ > 0.076 for N = 7, 8
157.1 > hᵤᵥ > 153.9 and Cᵤᵥ > 0.05 for N = 7, 8
163.6 > hᵤᵥ > 157.6 and Cᵤᵥ > 0.05 for N = 3, 4, 6
169.8 > hᵤᵥ > 163.8 and Cᵤᵥ > 0.05 for N = 5
183.0 > hᵤᵥ > 177.0 and Cᵤᵥ > 0.05 for N = 7, 8

3 to 20 interference pigments (N=3-20) are preferably selected as corner points of a mixture. N is very particularly preferably 4-12, and in particular N=5-8, where the optimum hue angles naturally depend on the number of interference pigments to be selected.

Suitable pigments are, in particular, interference pigments based on flake-form transparent substrates. Preferred substrates are phyllosilicates. Particularly suitable are natural and/or synthetic mica, flake-form aluminium oxides, glass flakes, SiO₂ flakes, TiO₂ flakes, synthetic support-free flakes, BiOCl or other comparable materials. The glass flakes, Al₂O₃ flakes and SiO₂ flakes may also be doped.

It is also possible to employ mixtures of different substrates or mixtures of identical substrates having different particle sizes. The substrates can be mixed with one another in any weight ratio. Preference is given to the use of 10:1 to 1:10 mixtures, in particular 1:1 mixtures. Particular preference is given to substrate mixtures consisting of mica flakes having different particle sizes, in particular mixtures of N mica (<60 μm) and F mica (<25 μm).

The size of the base substrates is not crucial per se and can be matched to the particular application.

In general, the flake-form substrates have a thickness between 0.05 and 5 μm, in particular between 0.1 and 1 μm. The size in the two other dimensions is usually between 1 and 250 μm, preferably between 2 and 200 μm and in particular between 5 and 60 μm.

The thickness of at least one individual layer on the base substrate is essential for the optical properties of the pigment. The pigment must have at least one optically active layer, preferably a high-refractive-index layer. High-refractive-index layers here are taken to mean all layers which have a refractive index of n>1.8, preferably n≧2.0.

The optical layer preferably consists of TiO₂, ZrO₂, SnO₂, ZnO, or mixtures or combinations thereof. The layer may be undoped or doped. Suitable dopants are, for example, alkaline-earth metals or compounds thereof, in particular calcium and magnesium. The doping proportion is generally at most 5% by weight, based on the respective layer.

The optical layer is particularly preferably a colourless layer, in particular a TiO₂ layer. The TiO₂ here can be in the rutile and in the anatase modification, preferably rutile.

The thickness of the optically active layer is preferably 30 to 350 nm, in particular 50 to 250 nm.

Particularly preferred interference pigments are mentioned below:

Mica flake+TiO₂
Mica flake+ZrO₂
SiO₂ flake+TiO₂
SiO₂ flake+ZrO₂
Al₂O₃ flake+TiO₂
Al₂O₃ flake+ZrO₂
Glass flake+TiO₂
Glass flake+ZrO₂
Glass flake+SiO₂+TiO₂

Suitable interference pigments are likewise multilayered pigments so long as they have at least one and at most two identical, optically active layers. Particular preference is given to multilayered pigments which have a TiO₂—SiO₂ (optically inactive layer)—TiO₂ layer sequence. Pigments of this type are known, for example, from EP 0 882 099 B1. The optically inactive layers are generally SiO₂ and/or Al₂O₃ layers having layer thicknesses of <10 nm, preferably <5 nm. In addition, the pigments may also comprise further auxiliary layers above or below the interference layer, for example for control of the rutilisation, the particle growth or for inhibiting the photoactivity.

The preparation of interference pigments has been described many times in the literature and is known to the person skilled in the art.

The metal-oxide layers are preferably applied by wet-chemical methods, it being possible to use the wet-chemical coating methods developed for the preparation of pearlescent pigments. Methods of this type are described, for example, in DE 14 67 468, DE 19 59 988, DE 20 09 566, DE 22 14 545, DE 22 15 191, DE 22 44 298, DE 23 13 331, DE 25 22 572, DE 31 37 808, DE 31 37 809, DE 31 51 343, DE 31 51 354, DE 31 51 355, DE 32 11 602, DE 32 35 017 or in further patent documents and other publications known to the person skilled in the art.

In the case of wet coating, the substrate particles are suspended in water, and one or more soluble metal salts are added at a pH which is suitable for hydrolysis, which is selected in such a way that the metal oxides or metal oxide hydrates are precipitated directly onto the flakes without secondary precipitations occurring. The pH is usually kept constant by simultaneous metered addition of a base or acid. The pigments are subsequently separated off, washed and dried and optionally calcined, where the calcination temperature can be optimised with respect to the coating present in each case. In general, the calcination temperatures are between 250 and 1000° C., preferably between 350 and 900° C. If desired, the pigments can be separated off, dried and optionally calcined after application of individual coatings and then re-suspended for precipitation of the further layers.

Furthermore, the coating can also be carried out by gas-phase coating in a fluidised-bed reactor, where, for example, the methods proposed for the preparation of pearlescent pigments in EP 0 045 851 and EP 0 106 235 can be used correspondingly.

The colour of the pigments can be varied in broad limits through a different choice of the coating amounts or the resultant layers. The fine tuning for a certain hue can be achieved beyond the pure choice of amount by approaching the desired colour under visual or measurement-technology control. The optimisation of colour location and chroma of the interference pigments is carried out via the thickness of the precipitated layers and through the choice of suitable precipitation parameters. Methods for this purpose are known to the person skilled in the art. Higher chromas of the interference pigments can also be achieved through the multilayered structures described in EP 0 882 099.

In order to increase the light, water and weather stability, it is frequently advisable, depending on the area of application, to subject the interference pigments to post-coating or post-treatment. Suitable post-coatings or post-treatments are, for example, the methods described in German Patent 22 15 191, DE-A 31 51 354, DE-A 32 35 017, DE-A 33 34 598, DE 40 30 727 A1, EP 0 649 886 A2, WO 97/29059, WO 99/57204, U.S. Pat. No. 5,759,255. This post-coating further increases the chemical stability of the pigments or simplifies handling of the pigment, in particular incorporation into various media. In order to improve the wettability, dispersibility and/or compatibility with the application media, functional coatings of Al₂O₃ or ZrO₂ or mixtures or mixed phases thereof can be applied to the pigment surface. Furthermore, organic or combined organic/inorganic post-coatings are possible, for example with silanes, as described, for example, in EP 0090259, EP 0 634 459, WO 99/57204, WO 96/32446, WO 99/57204, U.S. Pat. No. 5,759,255, U.S. Pat. No. 5,571,851, WO 01/92425 or in J. J. Ponjeé, Philips Technical Review, Vol. 44, No. 3, 81 ff. and P. H. Harding J. C. Berg, J. Adhesion Sci. Technol. Vol. 11 No. 4, pp. 471-493.

The pigment system according to the invention can be prepared by any of the processes mentioned by ensuring that the optically active layers have one of the hue angles from Table 1 or 2 after completion of the pigment (i.e. after calcination and surface modification).

The pigment system or mixture according to the invention is compatible with a multiplicity of colour systems, preferably from the area of paints, coatings and printing inks. For the preparation of the surface coatings, powder coatings, paints, printing inks, a multiplicity of binders is suitable. The binders may have a water-based or solvent-based structure.

The pigment system according to the invention is furthermore suitable for the preparation of flowable pigment compositions and dry preparations. The pigment compositions and dry preparations are distinguished by the fact that they comprise the pigment system according to the invention, binders and optionally one or more additives.

The interference pigment according to the invention can be used for the pigmentation of surface coatings, printing inks, plastics, agricultural sheeting, seed coating, food colourings, button pastes, medicament coatings or cosmetic formulations. The concentration of the pigment mixture in the application system to be pigmented is generally between 0.1 and 70% by weight, preferably between 0.1 and 50% by weight and in particular between 0.5 and 10% by weight, based on the total solids content of the system. It is generally dependent on the specific application.

In the paints sector, in particular in automobile paints or in the automotive refinish paints sector, the pigment system according to the invention is employed, including for 3-coat finishes, in amounts of 0.1-10% by weight, preferably 1 to 3% by weight.

It goes without saying that the pigment system according to the invention can also advantageously be employed for the various application purposes in a blend with organic dyes, organic pigments or other pigments, such as, for example, transparent and opaque white, coloured and black pigments. The system can be mixed with these commercially available pigments and fillers in any weight ratio.

The invention thus also relates to formulations comprising the pigment system according to the invention.

### BRIEF DESCRIPTION OF THE DRAWINGS

FIG. 1 depicts a theoretical curve E(u′,v′) for optical path lengths 10 nm<nd<1000 nm with light incidence below 45° to the surface perpendicular (thin line) and associated envelope curve (thick line).

FIG. 2 depicts a Gamut and colour coordinates u′,v′ of pigments 1-8 from Example 4, Table 3 (continuous curve), interference pigments from the prior art, as described on p. 16 (dashed gamut curve), the two individual dots are the colour coordinates of the commercial pigments from Example 5, all of which can be mimicked with respect to their colour locations by mixing pigments 1-8 according to the invention. The marking—empty circle—represents the achromatic point.

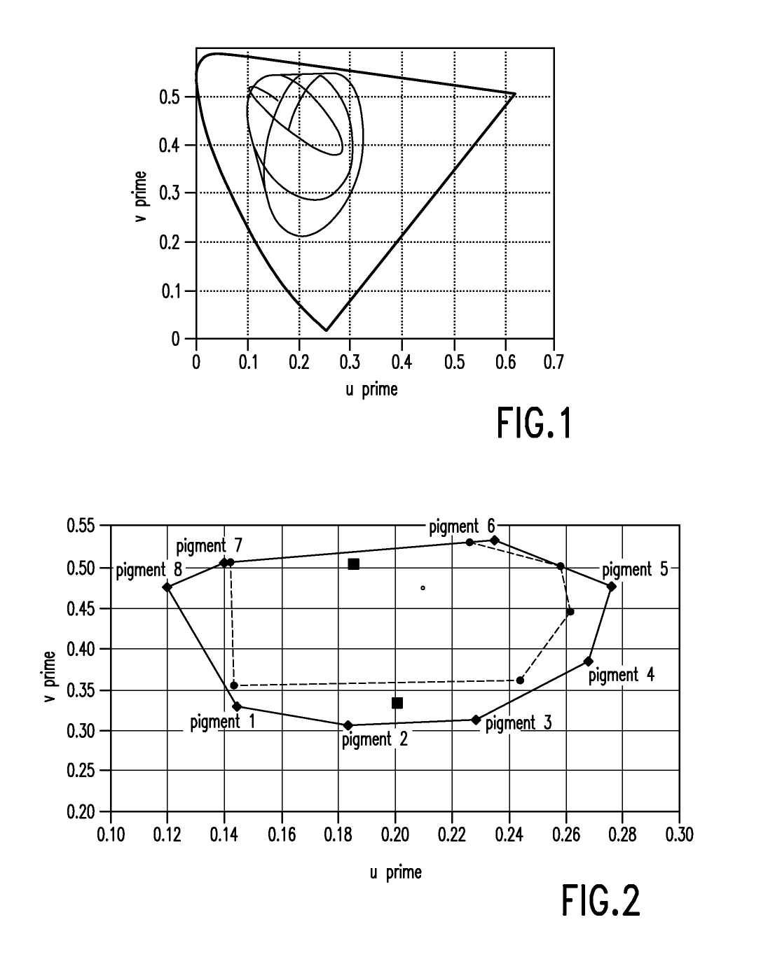

Further embodiments of this invention are revealed by the examples and the claims.

The following examples are intended to explain the invention, but without limiting it.

### EXAMPLES

### Preparation of the Interference Pigments

### Example 1

### Single-Layered Pigment

60 ml of an aqueous solution of 3 g of SnCl₄*5 H₂O and 10 ml of conc. hydrochloric acid are added over the course of one hour at 75° C. to a suspension of 100 g of ground and classified mica having a particle size of 10-60 μm in 2 l of water, during which a pH of 1.8 is maintained by simultaneous addition of dilute sodium hydroxide solution. An aqueous 20% by weight TiCl₄ solution is subsequently added, during which a pH of 1.6 is maintained using dilute sodium hydroxide solution.

After a green interference colour has been achieved, the mixture is stirred for about a further half an hour, the pigment is separated off, washed with water until salt-free, dried and calcined at 850° C. for 30 minutes.

Further coloured interference pigments can be prepared by this method by approaching defined cut-off points via the precipitated amount of TiO₂.

### Example 2

### Multilayered Pigment Having an Optically Inactive Layer

100 g of mica having a particle size of 10-60 μm are suspended in 2 l of demineralised water. The suspension, heated to 75° C., is adjusted to pH=1.8 using dilute hydrochloric acid. A coating of SnO₂ is subsequently applied by addition of 3.3 ml/min of SnCl₄ solution (prepared from 2.2 g of SnCl₄ and 0.75 g of conc. hydrochloric acid in 100 ml of demineralised water). During this addition, the pH is kept constant using 32% sodium hydroxide solution. The mixture is subsequently stirred for a further 15 min, and a TiCl₄ solution (400 g of TiCl₄/l) is added at pH=1.8 and 75° C., during which the pH is kept constant using 32% sodium hydroxide solution. After the IInd order green end point has been reached, the coating operation is interrupted, the mixture is stirred for a further 15 min, the pH is adjusted to 8.0 using dilute sodium hydroxide solution, and the mixture is stirred for a further 10 min.

The coating with SiO₂ is subsequently carried out by addition of 3 ml/min of sodium water-glass solution (prepared from 7.3 g of sodium water-glass comprising 27% of SiO₂ and 80 ml of demineralised water) without pH compensation. After completion, the mixture is stirred for a further 15 min, the pH is re-adjusted to 1.8 using dilute hydrochloric acid, and the second TiO₂ layer is precipitated by addition of SnCl₄ and TiCl₄ solution, as described above. After the IIIrd order green comparative end point has been reached, the coating operation is terminated, the mixture is stirred for a further 15 min, and the pigment is subsequently filtered off with suction, washed, dried and calcined at 850° C. for 30 min.

The multilayered pigment obtained has an intensely green interference colour.

### Example 3

### Preparation of a System Comprising Interference Pigments (Where N=3) Having a Maximised Colour Gamut Through Choice Of the Optimum Pigment Hue Angles h_{u′v′}

An interference pigment which corresponds to the required h_{u′v′} in the red, blue and green hue angle region is prepared in accordance with each of Preparation Examples 1 and 2 [wet-chemical precipitation of rutile on mica]. A coating film comprising about 16 m % of this pigment, applied pneumatically and having a thickness of 15 μm on a black substrate gives the following u′ and v′ colour value fractions on colorimetry in 45°/120° geometry:

| | u′ | v′ | hu′v′ |
|---|---|---|---|
| Red-copper type acc. to Example 1 | 0.267 | 0.4766 | 2.9 |
| Blue type acc. to Example 1 | 0.1791 | 0.3049 | −100.5 |
| Green type acc. to Example 2 | 0.1407 | 0.5043 | 156.3 |
| Gamut | | | 0.0121 |

By comparison, the commercially available interference pigments from Merck KGaA (prior art)

| | u′ | v′ | hu′v′ |
|---|---|---|---|
| Iriodin ® 9215 WR Rutile Red Pearl | 0.2636 | 0.4663 | −7.9 |
| Iriodin ® 9225 Rutil Pearl Blue WR | 0.1427 | 0.3702 | −123.3 |
| Iriodin ® 9235 Rutil Pearl Green WR | 0.1684 | 0.4915 | 157.0 |
| Gamut | | | 0.0061 |

Approaching the optimised hue angles (upper table) gives a significant enlargement of the colour gamut compared with three commercial interference pigments.

### Example 4

### Preparation of a System Comprising 8 Interference Pigments Having a Maximised Colour Gamut Through Choice of the Optimum Pigment Hue Angles h_{u′v′}

The following coloured interference pigments of optimised colour location and chroma from the colour regions blue, indigo, violet, purple, red, yellow, turquoise and green are synthesised by preparation process 1 or 2:

TABLE 3

| | Preparation | | | | | Optical layer | Colour |
|---|---|---|---|---|---|---|---|
| | process | u′ | v′ | Hue(u′v′) | δ | thickness | region |
| Pigment 1 | 2 | 0.1444 | 0.3292 | −114.61 | 0.3595 | 340.0 | blue |
| Pigment 2 | 2 | 0.1837 | 0.3052 | −99.06 | 0.3562 | 319.2 | indigo |
| Pigment 3 | 2 | 0.2284 | 0.3128 | −83.65 | 0.3873 | 302.0 | violet |
| Pigment 4 | 1 | 0.2682 | 0.3839 | −57.26 | 0.4683 | 287.7 | purple |
| Pigment 5 | 1 | 0.2765 | 0.4766 | 2.52 | 0.5510 | 273.0 | red |
| Pigment 6 | 1 | 0.2355 | 0.5325 | 67.02 | 0.5822 | 224.0 | yellow |
| Pigment 7 | 2 | 0.1403 | 0.5061 | 155.17 | 0.5252 | 412.0 | turquoise |
| Pigment 8 | 2 | 0.1201 | 0.4762 | 178.36 | 0.4912 | 425.0 | green |

In accordance with their hue angles h_{u′v′}, the constituents of the optimised hue angles mentioned in Table 1 and 2 are for the system comprising 8 pigments.

The colour locations and the resultant gamut curve of this system comprising 8 interference pigments are shown in FIG. 2.

### Example 5

### Comparative Example

Commercially available interference pigments of high tinting strength from the prior art (manufacturer: Merck KGaA) have the following characteristics on identical sample preparation and colorimetry:

| Pigment name | u′ | v′ | Hue(u′v′) | δ |
|---|---|---|---|---|
| Iriodin ® 97219 Ultra | 0.2445 | 0.3615 | −73.15 | 0.4364 |
| Rutile Lilac Pearl SW | | | | |
| Iriodin ® 97205 Ultra | 0.2270 | 0.5285 | 73.29 | 0.5752 |
| Rutile Platinum Gold WR | | | | |
| Iriodin ® 97225 Ultra | 0.1433 | 0.3547 | −119.47 | 0.3825 |
| Rutile Blue Pearl WR II | | | | |
| Iriodin ® 97215 Ultra | 0.2619 | 0.4455 | −28.75 | 0.5168 |
| Rutile Red Pearl WR II | | | | |
| Iriodin ® 97217 Ultra | 0.2584 | 0.5009 | 29.62 | 0.5636 |
| Rutile Copper WR II | | | | |
| Iriodin ® 97235 Ultra | 0.1426 | 0.5078 | 153.33 | 0.5274 |
| Rutile Green Pearl WR II | | | | |

The colour locations of these pigments (shown in FIG. 2—dashed) are all inside the gamut curve formed by the pigments according to the invention (in FIG. 2—black dots). It follows from this that the pigments from the prior art can be mimicked by a combination of a number of pigments according to the invention.

By way of example, two further commercially available pigments of high tinting strength in the purple and green colour region are measured:

| Pigment name | u′ | v′ | Hue(u′v′) | δ |
|---|---|---|---|---|
| DongZhu, TR235 green | 0.1859 | 0.5044 | 128.67 | 0.5376 |
| Engelhard, Super Violet 5303 Z | 0.2011 | 0.3320 | −93.81 | 0.3882 |

The colour locations of these two pigments are all inside the gamut curve formed by the pigments according to the invention (in FIG. 2—black squares).

The violet pigment (Engelhard, Super Violet 5303 Z) cannot be mimicked by a combination of any desired number of pigments from the prior art, since it lies outside the corresponding gamut (FIG. 2). By contrast, this mimicking can be achieved by the pigments of the salt from Table 3, indeed by a number of pigment mixtures.

Since the gamut of the pigments of the salt from Table 3 includes and exceeds the gamut of the pigments from the prior art, each colour location which can be mimicked by these pigments can likewise be mimicked by combinations of the pigments from Table 3.

The examples additionally show that colour locations which cannot be produced using pigments from the prior art can be achieved using the pigments according to the invention by mixing.

1. System comprising N≧3 interference pigments, characterised in that the interference pigments have a maximum colour gamut of the system at a C_{u′v′} of ≧0.05 and a pigment hue angle h_{u′v′}ⁱ (i=1 to N).

2. System comprising N≧3 interference pigments according to claim 1, characterised in that N=3-20.

3. System comprising N≧3 interference pigments according to claim 1 or 2, characterised in that the interference pigments are based on flake-form substrates.

4. System comprising N≧3 interference pigments according to one or more of claims 1 to 3, characterised in that the substrates are natural or synthetic mica flakes, undoped or doped SiO₂ flakes, undoped or doped Al₂O₃ flakes, undoped or doped glass flakes.

5. System comprising N≧3 interference pigments according to one or more of claims 1 to 4, characterised in that the interference pigments are TiO₂-coated flakes.

6. System comprising N≧3 interference pigments according to one or more of claims 1 to 5, characterised in that the coating layer comprising the pigment has the following hue angle and chroma ranges in the 45°/120° measurement geometry:
${h}_{{u}^{′} {v}^{′}} = arctan ( \frac{{v}^{′} - {v}_{n}^{′}}{{u}^{′} - {u}_{n}^{′}} ) δ = {S}_{{u}^{′} {v}^{′}} / 13$

| | | |
|---|---|---|
| −127.3 > hᵤᵥ > −133.3 | and Cᵤᵥ > 0.05 | for N = 6 |
| −112.2 > hᵤᵥ > −118.2 | and Cᵤᵥ > 0.14 | for N = 4, 5, 7, 8 |
| −112.2 > hᵤᵥ > −116.6 | and Cᵤᵥ > 0.05 | for N = 4, 5, 7, 8 |
| −96.4 > hᵤᵥ > −102.4 | and Cᵤᵥ > 0.05 | for N = 3, 6, 8 |
| −81.1 > hᵤᵥ > −87.1 | and Cᵤᵥ > 0.125 | for N = 5, 7, 8 |
| −81.1 > hᵤᵥ > −87.1 | and Cᵤᵥ > 0.05 | for N = 5, 7, 8 |
| −67.4 > hᵤᵥ > −73.4 | and Cᵤᵥ > 0.12 | for N = 4, 6 |
| −67.4 > hᵤᵥ > −72.7 | and Cᵤᵥ > 0.05 | for N = 4, 6 |
| −55.6 > hᵤᵥ > −61.6 | and Cᵤᵥ > 0.05 | for N = 7, 8 |
| −29.5 > hᵤᵥ > −35.5 | and Cᵤᵥ > 0.05 | for N = 5 |
| −9.8 > hᵤᵥ > −15.8 | and Cᵤᵥ > 0.062 | for N = 6 |
| −9.8 > hᵤᵥ > −12.7 | and Cᵤᵥ > 0.05 | for N = 6 |
| −3.4 > hᵤᵥ > −9.4 | and Cᵤᵥ > 0.057 | for N = 7, 8 |
| −3.4 > hᵤᵥ > −7.8 | and Cᵤᵥ > 0.05 | for N = 7, 8 |
| 3.2 > hᵤᵥ > −2.8 | and Cᵤᵥ > 0.05 | for N = 3 |
| 52.8 > hᵤᵥ > 46.8 | and Cᵤᵥ > 0.05 | for N = 4 |
| 67.7 > hᵤᵥ > 61.7 | and Cᵤᵥ > 0.05 | for N = 5, 6, 7, 8 |
| 157.1 > hᵤᵥ > 151.1 | and Cᵤᵥ > 0.076 | for N = 7, 8 |
| 157.1 > hᵤᵥ > 153.9 | and Cᵤᵥ > 0.05 | for N = 7, 8 |
| 163.6 > hᵤᵥ > 157.6 | and Cᵤᵥ > 0.05 | for N = 3, 4, 6 |
| 169.8 > hᵤᵥ > 163.8 | and Cᵤᵥ > 0.05 | for N = 5 |
| 183.0 > hᵤᵥ > 177.0 | and Cᵤᵥ > 0.05 | for N = 7, 8 |

7. Coloured interference pigments comprising one or more colourless metal-oxide layers on a transparent substrate, characterised in that the coating layer comprising the pigment has one of the following hue angles and chromas in the 45°/120° measurement geometry:
${h}_{{u}^{′} {v}^{′}} = arctan ( \frac{{v}^{′} - {v}_{n}^{′}}{{u}^{′} - {u}_{n}^{′}} ) δ = {S}_{{u}^{′} {v}^{′}} / 13$

| | |
|---|---|
| −127.3 > hᵤᵥ > −133.3 | and δ > 0.05 |
| −112.2 > hᵤᵥ > −118.2 | and δ > 0.14 |
| −112.2 > hᵤᵥ > −116.6 | and δ > 0.05 |
| −96.4 > hᵤᵥ > −102.4 | and δ > 0.05 |
| −81.1 > hᵤᵥ > −87.1 | and δ > 0.125 |
| −81.1 > hᵤᵥ > −87.1 | and δ > 0.05 |
| −67.4 > hᵤᵥ > −73.4 | and δ > 0.12 |
| −67.4 > hᵤᵥ > −72.7 | and δ > 0.05 |
| −55.6 > hᵤᵥ > −61.6 | and δ > 0.05 |
| −29.5 > hᵤᵥ > −35.5 | and δ > 0.05 |
| −9.8 > hᵤᵥ > −15.8 | and δ > 0.062 |
| −9.8 > hᵤᵥ > −12.7 | and δ > 0.05 |
| −3.4 > hᵤᵥ > −9.4 | and δ > 0.057 |
| −3.4 > hᵤᵥ > −7.8 | and δ > 0.05 |
| 3.2 > hᵤᵥ > −2.8 | and δ > 0.05 |
| 52.8 > hᵤᵥ > 46.8 | and δ > 0.05 |
| 67.7 > hᵤᵥ > 61.7 | and δ > 0.05 |
| 157.1 > hᵤᵥ > 151.1 | and δ > 0.076 |
| 157.1 > hᵤᵥ > 153.9 | and δ > 0.05 |
| 163.6 > hᵤᵥ > 157.6 | and δ > 0.05 |
| 169.8 > hᵤᵥ > 163.8 | and δ > 0.05 |
| 183.0 > hᵤᵥ > 177.0 | and δ > 0.05 |

8. Coloured interference pigments according to claim 7, characterised in that the metal-oxide layer consists of TiO₂, ZrO₂, ZnO₂, or mixtures or combinations thereof.

9. Coloured interference pigments according to claim 7 or 8, characterised in that the metal-oxide layer consists of TiO₂.

10. Coloured interference pigments according to one or more of claims 7 to 9, characterised in that the TiO₂ is in the rutile or anatase modification.

11. Coloured interference pigments according to one or more of claims 7 to 10, characterised in that the transparent substrate is selected from the group natural or synthetic mica flakes, undoped or doped SiO₂ flakes, undoped or doped Al₂O₃ flakes, undoped or doped glass flakes.

12. Process for the preparation of the coloured interference pigments according to one or more of claims 7 to 11, characterised in that the coating of the substrates is carried out by wet-chemical methods or in the gas phase.

13. Use of the coloured interference pigments according to one or more of claims 7 to 11 in paints, coatings, automotive paints, automotive refinish paints, industrial coatings, powder coatings, plastics, printing inks and in cosmetic formulations.

14. Use of the system comprising N≧3 interference pigments according to one or more of claims 1 to 6 in paints, coatings, automotive paints, automotive refinish paints, industrial coatings, powder coatings, plastics, printing inks and in cosmetic formulations.
